(19) United States
(12) Patent Application Publication
(10) Pub. No.: US 2018/0014063 A1
(43) Pub. Date: Jan. 11, 2018

(54) Method and Apparatus for Accessing a Terminal Device Camera to a Target Device

(71) Applicant: TENCENT TECHNOLOGY (SHENZHEN) COMPANY LIMITED, Shenzhen (CN)

(72) Inventor: Haopeng Liu, Shenzhen (CN)

(21) Appl. No.: 15/678,221

(22) Filed: Aug. 16, 2017

Related U.S. Application Data
(63) Continuation of application No. PCT/CN2016/077287, filed on Mar. 25, 2016.

(30) Foreign Application Priority Data
Apr. 10, 2015 (CN) 201510169161.8

(51) Int. Cl. H04N 21/4363; G06F 17/30; H04L 29/08; H04N 21/61

(52) U.S. Cl. CPC H04N 21/43637; H04N 21/6156; G06F 17/30268; H04L 67/06

(57) ABSTRACT

The present disclosure discloses a method and apparatus for accessing a terminal device camera to a target device. The method includes: establishing a connection channel between the terminal device camera and the target device; starting the terminal device camera and obtaining image data captured by the terminal device camera; and transmitting the obtained image data to the target device through the connection channel established.

### CROSS -REFERENCE TO RELATED APPLICATIONS

This application is a continuation of International Application No. PCT/CN2016/077287, filed on Mar. 25, 2016, which claims the benefit of and priority to Chinese Patent Application No. 201510169161.8 filed on Apr. 10, 2015 by Tencent Technology (Shenzhen) Co., Ltd. and entitled “METHOD AND APPARATUS FOR ACCESSING A TERMINAL DEVICE CAMERA TO A TARGET DEVICE”, the disclosures of which are incorporated herein by reference in their entirety.

### FIELD OF THE DISCLOSURE

The present disclosure relates to the wireless communication technology, and in particular, to a method and apparatus for accessing a terminal device camera to a target device.

### BACKGROUND OF THE DISCLOSURE

With the rapid development of science and technology, people have more and more demands for functions of a variety of household and office devices, and thus more and more intelligent devices have been merging. Besides of their original basic functions, these intelligent devices should also have functions to facilitate people to communicate with each other and exchange information with each other, which requires additional components such as cameras, microphones, global positioning system (GPS) and various sensors. For example, set-top boxes, TV boxes, and TVs with cameras are generated under these demands. Through the camera, people can carry out functions such as face recognition verification when playing game, video calls with other users, TV camera and TV video.

However, there are still a lot of devices without a camera component, such as set-top boxes, TV boxes, and TVs.

### SUMMARY OF THE DISCLOSURE

In view of the foregoing, in an aspect of the present disclosure, a method for accessing a terminal device camera to a target device is provided, and in another aspect of the present disclosure, an apparatus for accessing a terminal device camera to a target device is provided, to realize a camera function on the target device, and meanwhile save resources and reduce costs.

The present disclosure provides a method for accessing a terminal device camera to a target device, including:

establishing a connection channel between the terminal device camera and the target device;

starting the terminal device camera and obtaining image data captured by the terminal device camera; and

transmitting the obtained image data to the target device through the connection channel established.

The present disclosure provides a method for accessing a terminal device camera to a target device, including:

establishing a connection channel between the target device and the terminal device camera;

receiving image data from the terminal device camera through the connection channel established;

converting the image data into target image data.

The present disclosure provides an apparatus for accessing a terminal device camera to a target device, including: a processor and a memory; wherein the memory stores application modules executable by the processor; and the application modules comprise:

a first connection establishment module to establish a connection channel between the terminal device camera and the target device;

an image data obtaining module to start the terminal device camera and obtain image data captured by the terminal device camera; and

an image data transmission module to transmit the obtained image data to the target device through the connection channel established.

The present disclosure provides a terminal device, including a camera and the apparatus for accessing a terminal device camera to a target device mentioned above.

The present disclosure provides an apparatus for accessing a terminal device camera to a target device, including: a processor and a memory; wherein the memory stores application modules executable by the processor; and the application modules comprise:

a second connection establishment module to establish a connection channel between the target device and the terminal device camera;

an image data receiving module to receive image data from the terminal device camera through the connection channel established; and

an image data conversion module to convert the image data into target image data.

The present disclosure provides a target device, including the apparatus for accessing a terminal device camera to a target device.

As is seen from the foregoing, in the present disclosure, by establishing a connection channel between a target device and a terminal device camera, obtaining image data captured by the terminal device camera, and transmitting the obtained image data to the target device, the target device is connected by the terminal device camera to capture an image, and a camera function is realized on the target device, and since it is not necessary to install a camera on the target device, the cost of the target device is reduced; and meanwhile, since it not necessary to replace an existing target device, the resource is saved.

### BRIEF DESCRIPTION OF THE DRAWINGS

FIG. 1 is an exemplary flow chart of a method for accessing a terminal device camera to a target device according to an embodiment of the present disclosure;

FIG. 2 is an exemplary flow chart of another method for accessing a terminal device camera to a target device according to an embodiment of the present disclosure;

FIG. 3 is an exemplary configuration diagram of an apparatus for accessing a terminal device camera to a target device according to an embodiment of the present disclosure;

FIG. 4A to FIG. 4C are schematic diagrams of internal structures of a first connection establishment module according to an embodiment of the present disclosure;

FIG. 5 is a schematic configuration diagram of a terminal device according to an embodiment of the present disclosure;

FIG. 6 is an exemplary configuration diagram of an apparatus for accessing a terminal device camera to a target device according to an embodiment of the present disclosure;

FIG. 7A to FIG. 7C are schematic diagrams of internal structures of a second connection establishment module according to an embodiment of the present disclosure; and

FIG. 8 is a schematic configuration diagram of a target device according to an embodiment of the present disclosure.

### DETAILED DESCRIPTION OF THE DISCLOSURE

In order to realize a camera function for a target device, e.g., a set-top box, a TV box, a TV, a computer or a telephone, and at the same time saving resources and reducing costs, the embodiments of the present disclosure take a situation into account where many terminal devices are equipped with cameras, for example, mobile phones, iPads, and PCs being equipped with cameras, and are intended to enable a target device without a camera to use a camera on a terminal device to realize the camera function for the target device.

To make the objects, technical solutions, and advantages of the present disclosure more clearly understood, the present disclosure will be described in more detail with reference to the following embodiments.

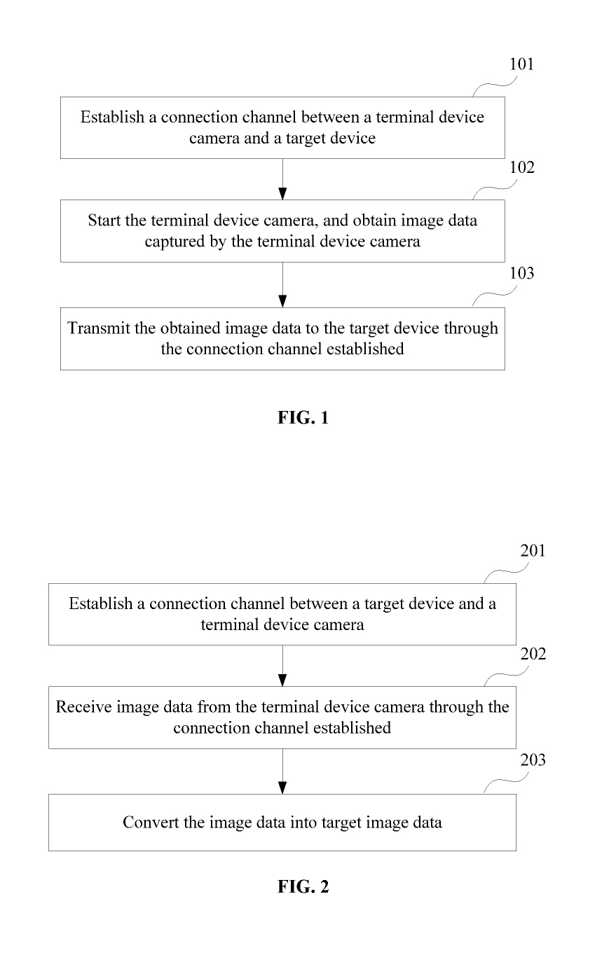

FIG. 1 is an exemplary flow chart of a method for accessing a terminal device camera to a target device according to an embodiment of the present disclosure. As shown in FIG. 1, the method may include the following blocks.

At block 101, a connection channel is established between a terminal device camera and a target device.

In the present embodiment, to enable the target device to use the terminal device camera, it is necessary to establish the connection channel between the terminal device camera and the target device. The connection channel may be a wireless transmission channel or a wired transmission channel. Several approaches to establish the connection of a wireless transmission channel are provided in the following:

First approach: the terminal device may use a browser that can realize a web real-time communication interface to establish a connection between the terminal device camera and the target device, for example, using an html 5 web to establish the connection. A detailed procedure of establishing the connection may include: the terminal device accessing to a network server (web server) pre-configured on the target device through the browser on the terminal device, and then establishing a web real-time communication (WebRtc) interface channel between the browser and the network server. Specifically, the terminal device may send a real-time communication interface channel connection request to the target device through the network server of the target device accessed using the browser on the terminal device, and receive a real-time communication interface channel connection response returned from the target device, thus completing the connection of the web real-time communication interface channel between the browser and the network server.

Second approach: the terminal device may establish a Bluetooth transmission channel between the terminal device camera and the target device using a Bluetooth video transmission protocol. In particular, the terminal device may send a Bluetooth transmission channel connection request to the target device using a Bluetooth video transmission protocol, and receive a Bluetooth transmission channel connection response returned from the target device, thus completing the connection of the Bluetooth transmission channel connection between the terminal device camera and the target device.

Third approach: the terminal device may establish a Bluetooth transmission channel between the terminal device camera and the target device using a private protocol. A detailed procedure may include the following:

the terminal device capturing identity information sent from the target device using the private protocol;

sending a connection establishment request to the target device according to identity information;

receiving a connection establishment response from the target device to complete the establishment of the connection channel between the terminal device camera and the target device.

At block 102, the terminal device camera is started and image data captured by the terminal device camera is obtained.

In the present embodiment, the image data may be continuous video stream data or may be static image data. In addition, there may be a variety of ways to start the terminal device camera and obtain the image data captured by the terminal device camera.

For example, corresponding to the first connection establishment approach in block 101, in this block, an application programming interface (API) of the browser may be used to start the terminal device camera and obtain the image data captured by the terminal device camera.

Corresponding to the second connection establishment approach and the third connection establishment approach in block 101, in this block, a preset image data obtaining module may be used to start the terminal device camera and obtain the image data captured by the terminal device camera.

At block 103, the obtained image data is transmitted to the target device through the connection channel established.

In this block, corresponding to the first connection establishment approach in block 101, the API may be used to transmit the obtained image data captured by the terminal device camera to the network server of the target device through the web real-time communication (WebRtc) interface channel. The network server may then transmit the image data to a camera driver module or an image data conversion module of the target device, and the camera driver module or the image data conversion module converts the image data into the target image data and provide the target image data to a third party application, such as an image recognition application in a game or a video call application.

Corresponding to the second connection establishment approach in block 101, a preset image data transmission module may be used to transmit the obtained image data captured by the terminal device camera to an image data receiving module of the target device through the Bluetooth transmission channel. Then the image data receiving module may transmit the image data to the camera driver module or the image data conversion module of the target device, and the camera driver module or the image data conversion module converts the image data into the target image data and provides the target image data to a third party application, such as an image recognition application in a game or a video call application.

Corresponding to the third connection establishment approach in block 101, the preset image data transmission module may be used to transmit the obtained image data captured by the terminal device camera to the image data receiving module of the target device through the private protocol connection channel. Then the image data receiving module may transmit the image data to the camera driver module or the image data conversion module of the target device, and the camera driver module or the image data conversion module then converts the image data into the target image data, and provides the target image data to a third party application, such as an image recognition application in a game or a video call application.

FIG. 2 is an exemplary flow chart of another method for accessing a terminal device camera to a target device according to an embodiment of the present disclosure. As shown in FIG. 2, the method may include the following blocks.

At block 201, a connection channel is established between a target device and a camera of the terminal device.

Corresponding to those in block 101, in this block, there may be the following several approaches to establish the connection channel between the target device and the terminal device camera:

Corresponding to the first connection establishment approach in block 101, in this block, the target device may establish a web real-time communication interface channel with a browser on the terminal device through a network server pre-configured on the target device. In particular, the target device may receive a real-time communication interface channel connection request sent to the target device by the network server of the target device accessed by the browser on the terminal device, and make a response, so as to complete the connection of the web real-time communication interface channel between the terminal device camera and the target device.

Corresponding to the second connection establishment approach in block 101, in this block, the Bluetooth video transmission protocol may also be used to establish the Bluetooth transmission channel between the terminal device camera and the target device. In particular, the target device may receive a Bluetooth transmission channel connection request sent from the terminal device and return a Bluetooth transmission channel connection response to the terminal device to complete the connection of the Bluetooth transmission channel between the terminal device camera and the target device.

Corresponding to the third connection establishment approach in block 101, in this step, the target device may send its own identity information using a private protocol; receive a connection establishment request from the terminal device and send a connection establishment response to the terminal device, so as to complete the establishment of the connection channel between the terminal device camera and the target device.

A block 202, image data from the terminal device camera is received through the connection channel established.

The image data may be continuous video stream data, or may be static image data.

In this block, corresponding to the first connection establishment approach in block 201, the network server of the target device may receive the image data from the terminal device camera through the web real-time communication (WebRtc) interface channel. The network server may then transmit the image data to the camera driver module or image data conversion module of the target device.

For the second connection establishment approach in block 201, the image data captured by the terminal device camera may be received by the image data receiving module of the target device through the Bluetooth transmission channel. The image data receiving module may then transmit the image data to the camera driver module or image data conversion module of the target device.

For the third connection establishment approach in block 201, the image data captured by the terminal device camera may be received by the image data receiving module of the target device through the private protocol connection channel. The image data receiving module may then transmit the image data to the camera driver module or image data conversion module of the target device.

At block 203, the image data is converted into target image data.

In this block, the image data may be converted into the target image data by the camera driver module or the image data conversion module of the target device, and may be provided to a third party application, such as an image recognition application in a game or a video call application.

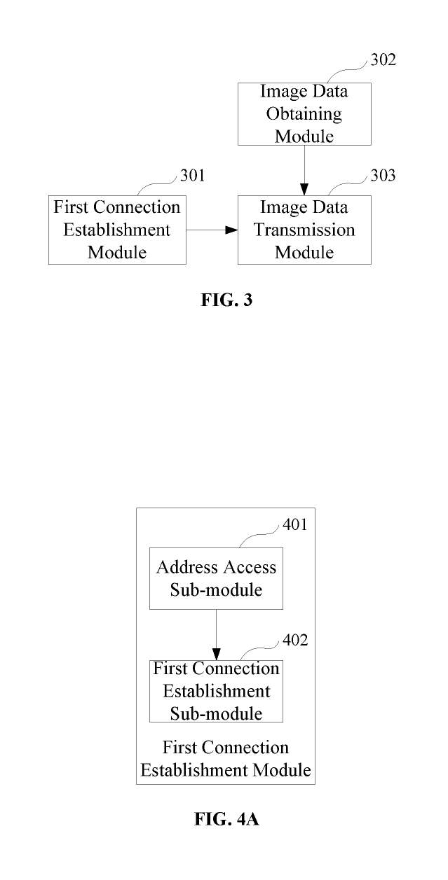

FIG. 3 is an exemplary configuration diagram of an apparatus for accessing a terminal device camera to a target device according to an embodiment of the present disclosure. As shown in FIG. 3, the apparatus may include a first connection establishment module 301, an image data obtaining module 302 and an image data transmission module 303.

The first connection establishment module 301 is to establish a connection channel between the terminal device camera and the target device. In particular, the first connection establishment module 301 may send a connection establishment request to the target device and receive a connection establishment response returned from the target device to complete establishment of the connection channel between the terminal device camera and the target device.

The image data obtaining module 302 is to start the terminal device camera and obtain the image data captured by the terminal device camera.

The image data transmission module 303 is to transmit the obtained image data to the target device through the connection channel established. The target device may then convert the image data into target image data for use in a third party application, such as an image recognition application in a game, or a video call application.

The specific operations of each module in the above apparatus may be consistent with the specific operations in the corresponding blocks shown in FIG. 1.

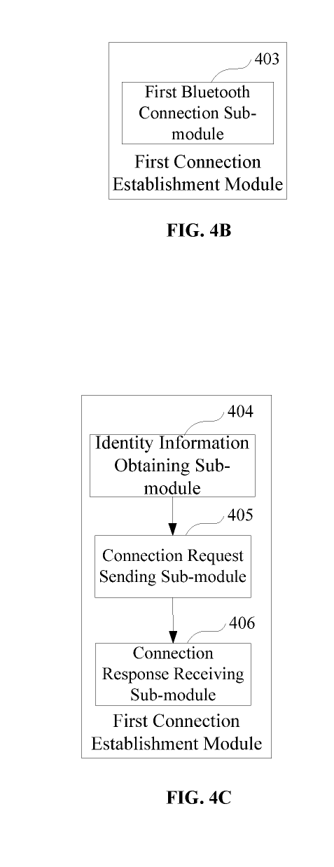

For example, FIG. 4A to FIG. 4C are schematic diagrams of internal structures of the first connection establishment module 301 according to an embodiment of the present disclosure, respectively.

As shown in FIG. 4A, in an embodiment, the first connection establishment module 301 may include an address access sub-module 401 and a first connection establishment sub-module 402.

The address access sub-module 401 is to access a network server pre-configured on the target device through a browser on the terminal device.

The first connection establishment sub-module 402 is to establish a web real-time communication interface channel between the browser and the network server. In particular, the first connection establishment sub-module 402 may send a real-time communication interface channel connection request to the target device through a network server of the target device accessed using a browser on the terminal device and receive a real-time communication interface channel connection response returned by the target device, thus completing the connection of the web real-time communication interface channel between the browser and the network server.

Accordingly, the image data obtaining module 302 may start the terminal device camera through an application programming interface (API) of the browser and obtain the image data captured by the terminal device camera. The image data transmission module 303 may transmit the image data to the network server of the target device through the web real-time communication (WebRtc) interface channel.

As shown in FIG. 4B, in yet another embodiment, the first connection establishment module 301 may include: a first Bluetooth connection sub-module 403 to establish a Bluetooth transmission channel between the terminal device camera and the target device using a Bluetooth video transmission protocol. In particular, the first Bluetooth connection sub-module 403 may send a Bluetooth transmission channel connection request to the target device using the Bluetooth video transmission protocol and receive a Bluetooth transmission channel connection response returned from the target device, thus completing the connection of the Bluetooth transmission channel between the target device and the terminal device camera.

Accordingly, the image data transmission module 303 may transmit the image data to an image data receiving module of the target device through the Bluetooth transmission channel.

As shown in FIG. 4C, in another embodiment, the first connection establishment module 301 may include an identity information obtaining sub-module 404, a connection request sending sub-module 405 and a connection response receiving sub-module 406.

The identity information obtaining sub-module 404 is to capture identity information sent from the target device using a private protocol.

The connection request sending sub-module 405 is to send a connection establishment request to the target device according to identity information.

The connection response receiving sub-module 406 is to receive a connection establishment response from the target device to complete the establishment of the connection channel between the terminal device camera and the target device.

In practical applications, the respective functional modules in the embodiment shown in FIG. 3 may be integrated in one processing unit, or may be individually provided as shown in FIG. 3, or may be further split into multiple sub-modules, or two or more modules may be integrated into one unit. The respective functional modules in the above embodiment may be implemented either in the form of hardware or in the form of software functional units, or may be implemented by combining hardware and computer-readable instructions. The respective functional modules may be distributed in an apparatus of the embodiment in accordance with the description of the embodiment, or may also be modified to be located in one or more apparatuses different from the present embodiment. For example, the functional modules in the apparatus embodiment described above may be computer-executable instructions executed by at least one processor.

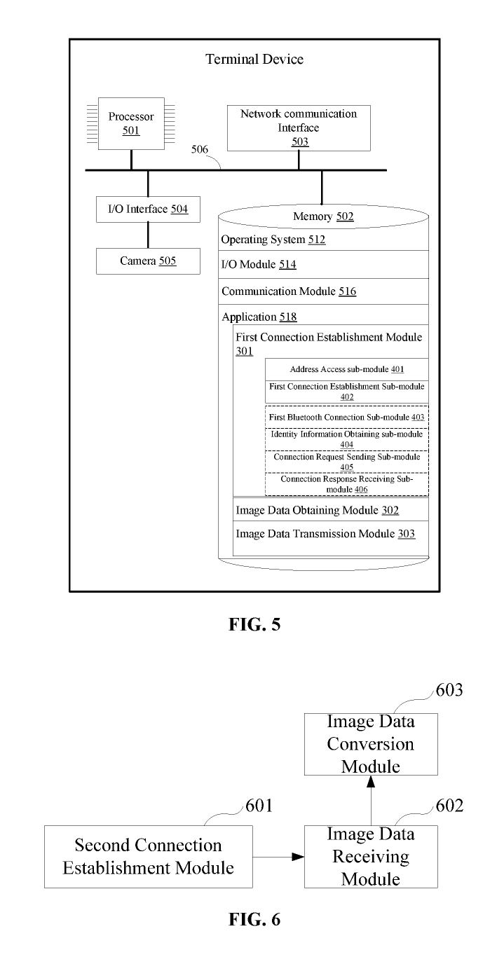

FIG. 5 is a schematic configuration diagram of a terminal device that uses the apparatus shown in FIG. 3 according to an embodiment of the present disclosure. The terminal device may be a smart phone, a handheld PC, a tablet PC, a PC and so on. As shown in FIG. 5, the terminal device may include a processor 501, a non-transitory computer-readable memory 502, a network communication interface 503, an I/O interface 504 and a camera 505. These components communicate with each other via a bus 506.

In an embodiment of the present disclosure, the memory 502 stores a plurality of program modules: an operating system 512, an I/O module 514, a communication module 516 and an application module 518.

The processor 501 may read the program modules in the memory 502 to perform various functional applications and data processing of the terminal device. The processor 501 in the present embodiment may be one or more, and may be a CPU (Central Processing Unit), a processing unit/module, an ASIC (Application Specific Integrated Circuit), a logic module or a programmable gate array.

Among them, the operating system 512 includes but is not limited to: Android operating system, Symbian operating system, Windows mobile operating system, and Apple iPhone OS operating system and so on.

In the embodiment of the present disclosure, the network communication interface 503 cooperates with the communication module 516 to transmit and receive various network signals of the terminal device.

In the embodiment of the present disclosure, the I/O interface 504 is connected to the camera 505. In addition, there may be other I/O interfaces for connection to other input/output devices such as touch panels (e.g., touch screens). The I/O interface 504 sends the image data received from the camera 505 to the I/O module 514 for processing.

The application module 518 may include various functional modules in the apparatus shown in FIG. 3. These functional modules may be computer-executable instructions that are executed by the processor 501. The image data obtaining module 302 may be used to obtain the image data captured by the camera 505 through the I/O module 514.

FIG. 6 is an exemplary configuration diagram of an apparatus for accessing a terminal device camera to a target device according to embodiments of the present disclosure. As shown in FIG. 6, the apparatus may include a second connection establishment module 601, an image data receiving module 602 and an image data conversion module 603.

The second connection establishment module 601 is to establish a connection channel between the target device and the terminal device camera. In particular, the second connection establishment module 601 may be used to receive a connection establishment request sent by the terminal device and return a connection establishment response to the terminal device to complete the establishment of the connection channel between the terminal device camera and the target device.

The image data receiving module 602 is to receive image data from the terminal device camera through the connection channel.

The image data conversion module 603 is to convert the image data into target image data.

The specific operations of each module in the above apparatus may be consistent with the specific operations in the corresponding blocks shown in FIG. 2.

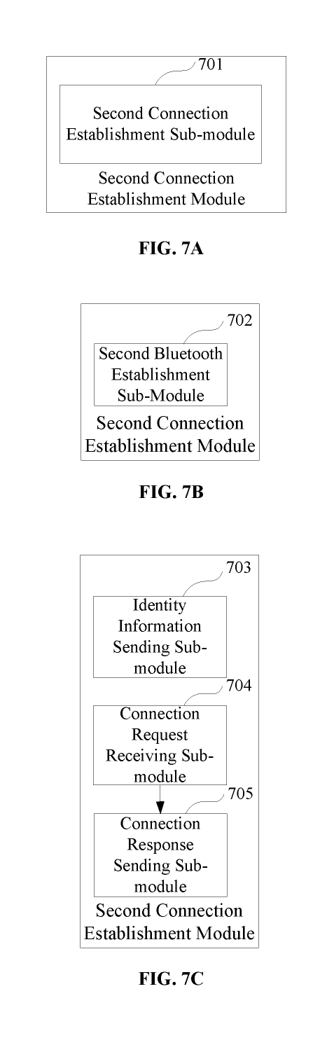

For example, FIGS. 7A to 7C are schematic diagrams of internal structures of the second connection establishment module 501 according to an embodiment of the present disclosure, respectively.

As shown in FIG. 7A, in an embodiment, the second connection establishment module 601 may include: a second connection establishment sub-module 701 to establish a web real-time communication interface channel with a browser on the terminal device through a network server pre-configured on the target device. In particular, the second connection establishment sub-module 701 may receive a real-time communication interface channel connection request sent by the target device through the network server of the target device and return a real-time communication interface channel connection response to the terminal device, thus completing the connection of the web real-time communication interface channel connection.

As shown in FIG. 7B, in yet another embodiment, the second connection establishment module 601 may include a second Bluetooth connection sub-module 702 to establish a Bluetooth transmission channel between the terminal device camera and the target device using a Bluetooth video transmission protocol. In particular, the second Bluetooth connection sub-module 702 may receive a Bluetooth transmission channel connection request sent by the terminal device and return a Bluetooth transmission channel connection response to the terminal device to complete the connection of the Bluetooth transmission channel.

As shown in FIG. 7C, in another embodiment, the second connection establishment module 601 may include an identity information sending sub-module 703, a connection request receiving sub-module 704 and a connection request response sending sub-module 705.

The identity information sending sub-module 703 is to send identity information of the target device using a private protocol.

The connection request receiving sub-module 704 is to receive a connection establishment request from the terminal device.

The connection response sending sub-module 705 is to send a connection establishment response to the terminal device to complete the establishment of the connection channel between the terminal device camera and the target device.

In practical applications, the respective functional modules in the embodiment shown in FIG. 6 may be integrated in one processing unit, or may be individually provided as shown in FIG. 6, or may be further split into multiple sub-modules, or two or more modules may be integrated into one unit. The respective functional modules in the above embodiment may be implemented either in the form of hardware or in the form of software functional units, or may be implemented by combining hardware and computer-readable instructions. The respective functional modules may be distributed in an apparatus of the embodiment in accordance with the description of the embodiment, or may also be modified to be located in one or more apparatuses different from the present embodiment. For example, the functional modules in the apparatus embodiment described above may be computer-executable instructions executed by at least one processor.

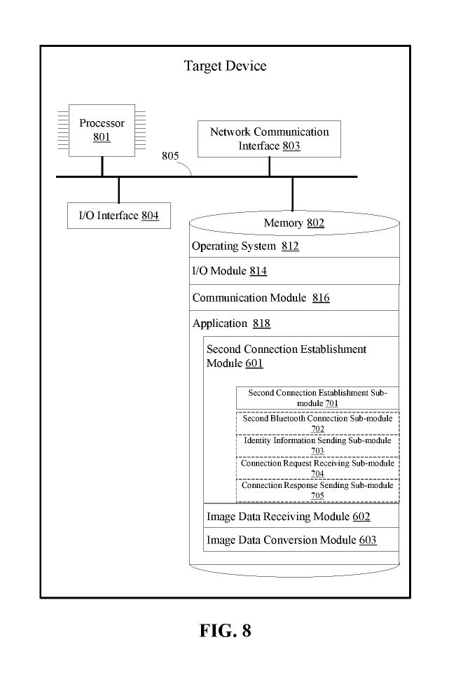

FIG. 8 is a schematic configuration diagram of a target device that uses the apparatus shown in FIG. 6 according to an embodiment of the present disclosure. The target device may be a set-top box, a TV box, a smart TV, a computers, a smart phone and so on. As shown in FIG. 8, the target device may include a processor 801, a non-transitory computer-readable memory 802, a network communication interface 803 and an I/O interface 804. These components communicate with each other via a bus 805.

In an embodiment of the present disclosure, the memory 802 stores a plurality of program modules: an operating system 812, an I/O module 814, a communication module 816 and an application module 818.

The processor 801 may read the program modules in the memory 802 to perform various functional applications and data processing of the terminal device. The processor 801 in the present embodiment may be one or more, and may be a CPU, a processing unit/module, an ASIC, a logic module or a programmable gate array.

Among them, the operating system 812 includes but is not limited to: Android operating system, Symbian operating system, Windows mobile operating system, and Apple iPhone OS operating system and so on.

In the embodiment of the present disclosure, the network communication interface 803 cooperates with the communication module 816 to transmit and receive various network signals of the target device.

In the embodiment of the present disclosure, the I/O interface 804 connects with an input/output device such as a remote controller, or a keyboard. The I/O interface 804 cooperates with the I/O module 814 to perform various input/output operations of the target device.

The application module 818 may include various functional modules in the apparatus shown in FIG. 6. These functional modules may be computer-executable instructions executed by the processor 801.

In addition, each embodiment of the present disclosure may be implemented by a data processing program executed by a data processing device such as a computer. Obviously, the data processing program constitutes the present disclosure. In addition, the data processing program which is typically stored in a storage medium, is executed by reading the data processing program from the storage medium or by installing or copying the data processing program to a storage device (such as a hard disk and/or memory) of the data processing device. Accordingly, such a storage medium also constitutes the present disclosure. The storage medium may adopt any recording type, e.g., a paper storage medium (e.g., a paper tape), a magnetic storage medium (e.g., a floppy disk, a hard disk, or a flash memory), an optical storage medium (e.g., a CD-ROM (Compact Disc Read-Only Memory)), a magneto-optical storage medium (e.g., a MO (magneto-optical disk)).

Accordingly, the present disclosure also provides a storage medium, in which a data processing program is stored, and the data processing program is used to perform any method embodiment of the present disclosure mentioned above.

The foregoing is only embodiments of the present disclosure, and should not be construed as limitations to the present disclosure. Any modification, equivalent substitution, and improvement without departing from the spirit and principle of the present disclosure should fall within the scope of the present disclosure.

1. A method for accessing a terminal device camera to a target device, comprising:
establishing a connection channel between the terminal device camera and the target device;
starting the terminal device camera and obtaining image data captured by the terminal device camera; and
transmitting the obtained image data to the target device through the connection channel established.

2. The method of claim 1, wherein establishing the connection channel between the terminal device camera and the target device comprises:
accessing to a network server pre-configured on the target device through a browser on a terminal device;
establishing a web real-time communication interface channel between the browser and the network server.

3. The method of claim 2, wherein starting the terminal device camera and obtaining the image data captured by the terminal device camera comprises:
starting the terminal device camera through an application programming interface (API) of the browser, and obtaining the image data captured by the terminal device camera.

4. The method of claim 1, wherein establishing the connection channel between the terminal device camera and the target device comprises:
establishing a Bluetooth transmission channel between the terminal device camera and the target device using a Bluetooth video transmission protocol.

5. The method of claim 1, wherein establishing the connection channel between the terminal device camera and the target device comprises:
capturing identity information sent by the target device using a private protocol;
sending a connection establishment request to the target device according to the identity information; and
receiving a connection establishment response from the target device to complete establishment of the connection channel between the terminal device camera and the target device.

6. The method of claim 1, wherein the method further comprises:
receiving, by the target device, the image data, and converting the image data into target image data.

7. A method for accessing a terminal device camera to a target device, comprising:
establishing a connection channel between the target device and the terminal device camera;
receiving image data from the terminal device camera through the connection channel established;
converting the image data into target image data.

8. The method of claim 7, wherein establishing the connection channel between the target device and the terminal device camera comprises:
establishing a web real-time communication interface channel with a browser on a terminal device through a network server pre-configured on the target device; or
establishing a Bluetooth transmission channel between the terminal device camera and a target device using a Bluetooth video transmission protocol; or
sending, by the target device, identity information of the target device using a private protocol; receiving a connection establishment request from the terminal device, and sending a connection establishment response to the terminal device to complete establishment of the connection channel between the terminal device camera and the target device.

9. An apparatus for accessing a terminal device camera to a target device, comprising: a processor and a memory; wherein the memory stores application modules executable by the processor; and the application modules comprise:
a first connection establishment module to establish a connection channel between the terminal device camera and the target device;
an image data obtaining module to start the terminal device camera and obtain image data captured by the terminal device camera; and
an image data transmission module to transmit the obtained image data to the target device through the connection channel established.

10. The apparatus of claim 9, wherein the first connection establishment module comprises:
an address access sub-module to access to a network server pre-configured on the target device through a browser on a terminal device; and
a first connection establishment sub-module to establish a web real-time communication interface channel between the browser and the network server.

11. The apparatus of claim 10, wherein the image data obtaining module starts the terminal device camera through an application programming interface (API) of the browser and obtains the image data captured by the terminal device camera.

12. The apparatus of claim 9, wherein the first connection establishment module comprises:
a first Bluetooth connection sub-module to establish a Bluetooth transmission channel between the terminal device camera and the target device using a Bluetooth video transmission protocol.

13. The apparatus of claim 9, wherein the first connection establishment module comprises:
an identity information obtaining sub-module to capture identity information sent by the target device using a private protocol;
a connection request sending sub-module to send a connection establishment request to the target device according to the identity information; and
a connection response receiving sub-module to receive a connection establishment response from the target device to complete establishment of the connection channel between the terminal device camera and the target device.
